(19) United States
(12) Patent Application Publication
(10) Pub. No.: US 2005/0003946 A1
(43) Pub. Date: Jan. 6, 2005

(54) Rotary-cutting disk for a centrifuge

(75) Inventors: Ludger Thiemann, Oelde (DE); Volker Kassera, Starzach-Sulzau (DE)

Correspondence Address: BARNES & THORNBURG, 750-17TH STREET NW, SUITE 900, WASHINGTON, DC, 20006, US

(73) Assignee: Westfalia Separator AG

(21) Appl. No.: 10/798,264

(22) Filed: Mar. 12, 2004

(30) Foreign Application Priority Data
Mar. 14, 2003 (DE) 103 11 610.9-23

(51) Int. Cl. B04B 11/08

(52) U.S. Cl. 494/56

(57) ABSTRACT

The present disclosure relates to a rotary-cutting disk for a centrifuge. The rotary-cutting disk includes a disk-shaped base section adjoined by a tube-shaped section. Also included is at least one draining duct for a liquid phase in the base section, the draining duct extending at an acute angle from an inlet at an outer circumference of the base section and in a flow direction of a liquid phase. The at least one draining duct includes walls extending from the inlet to an outlet. At least one of the walls of the draining duct is at least partially or in sections contoured in a wave shape.

The invention relates to a rotary-cutting disk having a draining duct for a liquid phase from a centrifuge, particularly from a separator.

Rotary-cutting disks—also called grippers—for centrifuges are known in many different embodiments; thus from U.S. Pat. No. 2,667,338. It is their object to drain a liquid phase from a centrifuge. Because of the type of their construction, many of the known solutions require high expenditures for their manufacture. Examples of this type are shown in European Patent Document EP 0 892 680 B1, International Patent Document PCT/SE88/00181, U.S. Pat. No. 4,406,652, U.S. Pat. No. 2,230,210 or European Patent Document EP 0 756 523 B1.

British Patent Document GB 987023 and European Patent Document EP 0 756 523 are also mentioned with respect to the state of the art.

In practice, depending on the number of liquid phases to be drained, one or more of the rotary-cutting disks are arranged concentrically with respect to the axis of rotation of the centrifuge. Thus, it is known, for example, to place the rotary-cutting disks onto an intake tube of a separator. Furthermore, generally, the rotary-cutting disks have a disk-shaped or plate-shaped base section preferably adjoined by a tube-shaped section. They generally stand still relative to the rotating centrifuge. They have at least one draining duct by means of which liquid is again diverted from the inlet at the outer circumference of the disk-shaped section to the outlet in one or more axial draining duct/ducts in the tube-shaped section and, from there, is drained from the centrifuge. The at least one draining duct diverts the liquid in the disk-shaped section in the case of a known variant, for example, by slightly more than 90° from the flow direction at the outer circumference of the rotary-cutting disk in a curve toward the inside.

It is known to align the inlet of the draining duct at an acute angle with respect to the flow direction and to then lead it from the outer circumference of the rotary-cutting disk in a curve toward the inside.

This construction has been successful per se. Particularly the effect of the cavitation has been a problem. It is an object of the invention to reduce this effect of the cavitation and preferably also reduce the stimulation of liquid-excited vibrations.

The invention achieves this task by means of the object of claim 1.

Advantageous further developments are contained in the subclaims.

According to the invention, at least one wall or the wall contour of the draining duct, completely or in sections, has a wave-shaped construction. The wave shape is preferably formed by at least one wave contour which has at least one reversing point. The wave contours reduce the cavitation effect, particularly in the corner area, and additionally reduce the effect of liquid-excited vibrations. In this respect, it is advantageous for the slope α of the wave contours to be smaller than 20° in their reversing points relative to the normal curve line K.

In the following, the invention will be described in detail by means of embodiments with reference to the drawing.

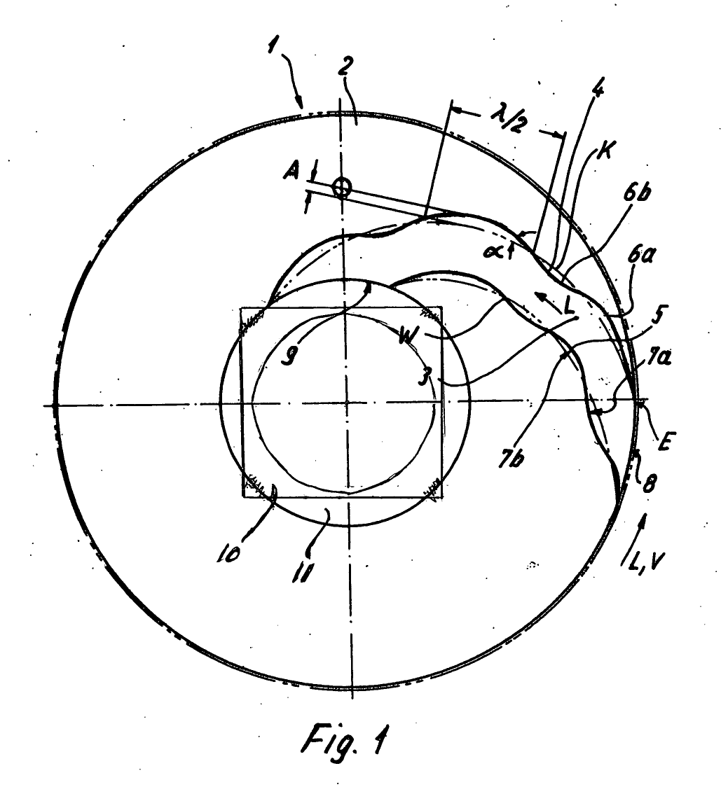

FIG. 1 is a cross-sectional view of a rotary-cutting disk perpendicular to the axis of rotation.

The rotary-cutting disk 1 has a usually axially relatively short, cylindrical, disk-shaped base section 2 which, perpendicular to the projection plane, is adjoined by a tube-shaped section of a smaller diameter, which is not shown here.

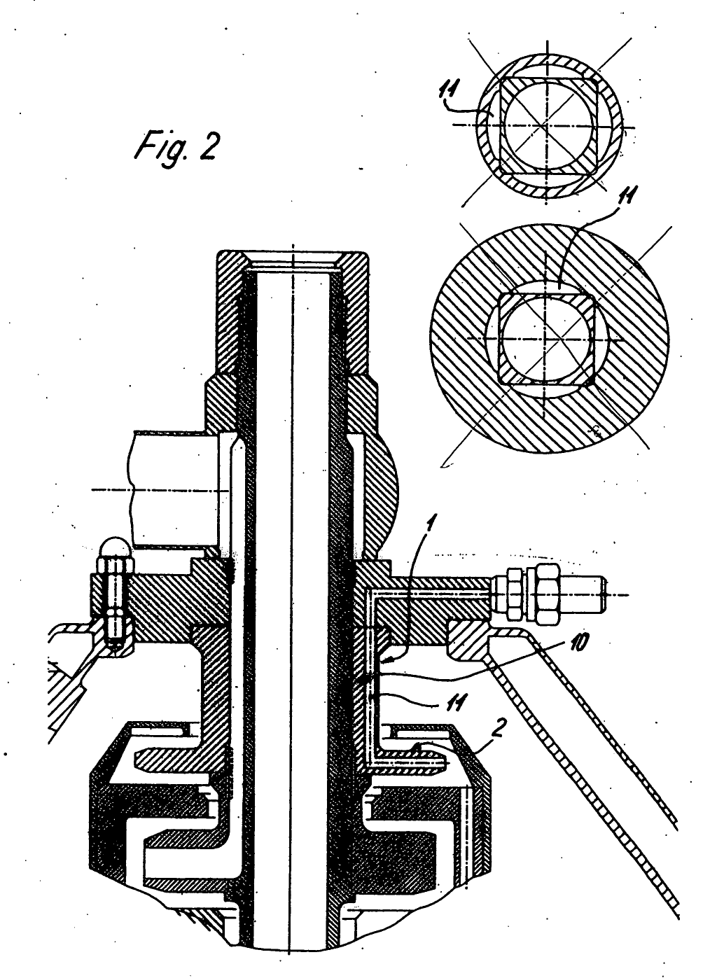

FIG. 2—from German Patent Document DE 199 12 773 A1—shows how a tube-shaped section 10 may look, for example, according to the state of the art or also according to the invention, where this area is preferably not changed.

A draining duct 3 for a liquid phase is constructed in the disk-shaped section 2. Relative to the flow direction of the liquid L, the inlet 8 of the draining duct 3 is aligned at an acute angle. Then, the draining duct 3 extends from the outer circumference of the rotary-cutting disk 1 in a curve toward the inside. Here, an approximate deflection by slightly more than 90° takes place in the disk-shaped section in a ring duct around the intake tube or one or more ducts 11 (for example, of the type of FIG. 2) at the shaft.

For improving the flow conditions and for reducing the cavitation, at least the contour of a wall 4, 5—in the case of a round or polygonal, particularly rectangular—cross-section, completely or in sections, has a wave-shaped further development or is provided with at least one wave contour 6a, 6b; 7a, 7b.

A wave of a wavelength λ, according to the definition, consists of two (half-) wave contours 6a and 6b or 7a and 7b, which, relative to a normal curve line K illustrated here by a broken line, which extends through the reversing points of the wave, are positively and negatively aligned and which each have wavelength of λ/2.

Preferably, the wall 4, 5 has no sharp edges from the inlet 8 to the outlet 9; that is, a function (such as a sine function) describing the contour of the wall(s) 4, 5 can be differentiated at any point with the exception of the inlet and the outlet 8,9, from the draining duct 3 and with the exception of the corner areas (for example, in the case of a cross-section which is not round and is rectangular).

Preferably, a plurality of wave contours 6a, 6b; 7a, 7b is provided. At least one wall should be equipped at least in sections with a (half) wave contour 7a, particularly in the inlet area and, again particularly advantageously, the wall 5 which is situated opposite the acute-angle corner area E.

With respect to their geometry, the wave contours 6a, 6b; 7a, 7b may—but do not have to—follow a trigonometric formula, such as a sinusoidal curve. Their wave length λ/2 should be greater, particularly at least two times greater than its amplitude A.

According to another variant, it is also conceivable that the wave contours are mutually phase-shifted at the different walls. In the various areas of the wall(s) of the draining duct 3, equiphase or not equiphase wave contours 6a, 6b; 7a, 7b may therefore be constructed in the wall; or equiphase wave contours 6a, 6b; 7a 7b may be situated opposite one another (for example, such that the width of the draining duct is constant), or, for example, opposite-phase wave contours may also be formed.

According to a variant, the wavelength may also change from the inlet 8 to the outlet 9; that is, increase or decrease continuously. In particular, this further reduces undesirable vibration effects.

Advantageously, the slope α of the wave contours, at their reversing points W, amounts to less than 20° relative to the preferably reversing-point-free normal curve line K through the reversing points W.

The liquid L flows into the draining duct 3 at a velocity v. The wave contours 6, 7 reduce the cavitation effect, particularly in the corner area E.

### LIST OF REFERENCE SYMBOLS

Rotary-cutting disk 1
base section 2
draining duct 3
flow direction V
wall 4, 5
wave contours 6a, 6b; 7a, 7b
inlet 8
outlet 9
tube-shaped section 10
duct 11
wavelength λ
amplitude A
liquid L
normal curve line K
reversing points W
corner area E
slope α

1. A rotary-cutting disk for a centrifuge, comprising:
a disk-shaped base section adjoined by a tube-shaped section;
at least one draining duct for a liquid phase in the base section, the draining duct extending at an acute angle from an inlet at an outer circumference of the base section and in a flow direction of the liquid phase, the flow direction starting in a curved manner toward an inside of the disk;
the at least one draining duct having walls extending from the inlet to an outlet, and
at least one of the walls of the draining duct being at least partially or in sections contoured in a wave shape.

2. The rotary-cutting disk according to claim 1, wherein the wave shape is formed by at least one wave contour having at least one reversing point.

3. The rotary-cutting disk according to claim 1, wherein a mathematical function describing a contour of at least one of the walls is differentiated at each point along that wall with the exception of the inlet and the outlet and with the exception of an angular corner area of the at least one draining duct.

4. The rotary-cutting disk according to claim 1, wherein at least one of the walls is provided at least in sections with a wave contour.

5. The rotary-cutting disk according to claim 1, wherein at least one of the walls is provided in sections with a wave contour at least over a first half of a path of the at least one draining duct.

6. The rotary-cutting disk according to claim 1, wherein wave contours are constructed on at least one of the walls according to a trigonometric formula.

7. The rotary-cutting disk according to claim 1, wherein wave contours are constructed according to a sinusoidal curve.

8. The rotary-cutting disk according to claim 6 wherein a length λ/2 of the wave contours is greater, than an amplitude A of the wave contours.

9. The rotary-cutting disk according to claim 1, wherein equiphase wave contours are constructed in different areas of at least one of the walls of the draining duct.

10. The rotary-cutting disk according to claim 1, wherein non-equiphase wave contours are constructed in different areas of at least one of the walls of the draining duct.

11. The Rotary-cutting disk according to claim 1, wherein a length λ/2 of wave contours of at least one of the walls of the at least one draining duct changes from the inlet to the outlet.

12. The rotary-cutting disk according to claim 1, wherein a length λ/2 of wave contours of at least one of the walls of the at least one draining duct increases continuously from the inlet to the outlet.

13. The rotary-cutting disk according to claim 1, wherein wave contours are mutually phase-shifted at the walls of the at least one draining duct.

14. The rotary-cutting disk according to claim 1, wherein a slope α of wave contours of at least one of the walls of the at least one draining duct is smaller than 20° relative to a normal curve line K in reversing points of the wave contours.

15. The rotary-cutting disk of claim 8, wherein the length λ/2 is at least two times greater than the amplitude A of the wave contours.

16. The rotary-cutting disk according to claim 7, wherein a length λ/2 of the wave contours is greater than an amplitude A of the wave contours.

17. The rotary-cutting disk of claim 16, wherein the length λ/2 is at least two times greater than the amplitude A of the wave contours.
